(19) United States
(12) Patent Application Publication
(10) Pub. No.: US 2007/0044015 A1
(43) Pub. Date: Feb. 22, 2007

(54) Control apparatus and control method for controlling device connected to computer network

(75) Inventor: Shingo Ikeda, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/452,408

(22) Filed: Jun. 14, 2006

(30) Foreign Application Priority Data
Jun. 17, 2005 (JP) 2005-178152

(51) Int. Cl. G06F 17/00

(52) U.S. Cl. 715/517

(57) ABSTRACT

A control apparatus for controlling a controlled apparatus connected to a computer network via the computer network, the control apparatus including: a detection unit that detects a type of the controlled apparatus; a storage unit that stores operation guide information for generating an operation guide as a graphical user interface to control the controlled apparatus; an operation image display unit that displays the operation guide, in which a function among a plurality of functions defined by the operation guide information is activated in accordance with the type detected by the detection unit, the function being operative in the controlled apparatus; and a transmission unit that transmits to the controlled apparatus via the computer network a control signal for performing a control responsive to a user operation input through the operation guide displayed by the operation image display unit.

### CROSS-REFERENCE TO RELATED APPLICATIONS

This application is based upon and claims the benefit of priority from Japanese Patent Application No. 2005-178152, filed on Jun. 17, 2005, the entire contents of which are incorporated herein by reference.

### BACKGROUND

1. Field

One embodiment relates to a control apparatus and a control method for controlling a device connected to a computer network.

2. Description of the Related Art

Hitherto, there is known a technique that displays a control panel of a multimedia device and a state of the multimedia device on a control screen automatically when the multimedia device is simply connected to a computer network such as LAN (Local Area Network). The technique enables the user to turn on/off a power of the multimedia device, to control the multimedia device in various manners, and to switch input source and output destination device in the multimedia device. Refer to JP-A-07-044477 for an example of such technique.

In a conventional control apparatus used in the technique, a remotely controlled device sends GUI (Graphical User Interface) data used for operating the remotely controlled device and characteristic information describing items to examine the features of the remotely controlled device to a remotely controlling device. The remotely controlling device uses the GUI data and the characteristic information to remotely control the remotely controlled device. Thus, in the conventional control apparatus, it is necessary for the remotely controlled device to transmit a large number of pieces of data and information to the remotely controlling device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate an embodiment of the invention and not to limit the scope of the invention.

FIG. 1 is an exemplary drawing to schematically show the appearance of a digital TV broadcast receiver incorporating a control apparatus of the invention and an example of a network system configured centering on the digital TV broadcast receiver;

FIG. 2 is an exemplary block diagram to show the main signal processing channel of the digital TV broadcast receiver;

FIG. 3 is an exemplary drawing provided by extracting the configuration of a part shown in FIG. 1;

FIG. 4 is an exemplary drawing to show an example of a GUI displayed on a video display;

FIG. 5 is an exemplary flowchart to describe the operation of the digital TV broadcast receiver; and

FIGS. 6A-6D are exemplary drawings to show examples of the GUI displayed on the video display.

### DETAILED DESCRIPTION

An embodiment will be described below with reference to the accompanying drawings.

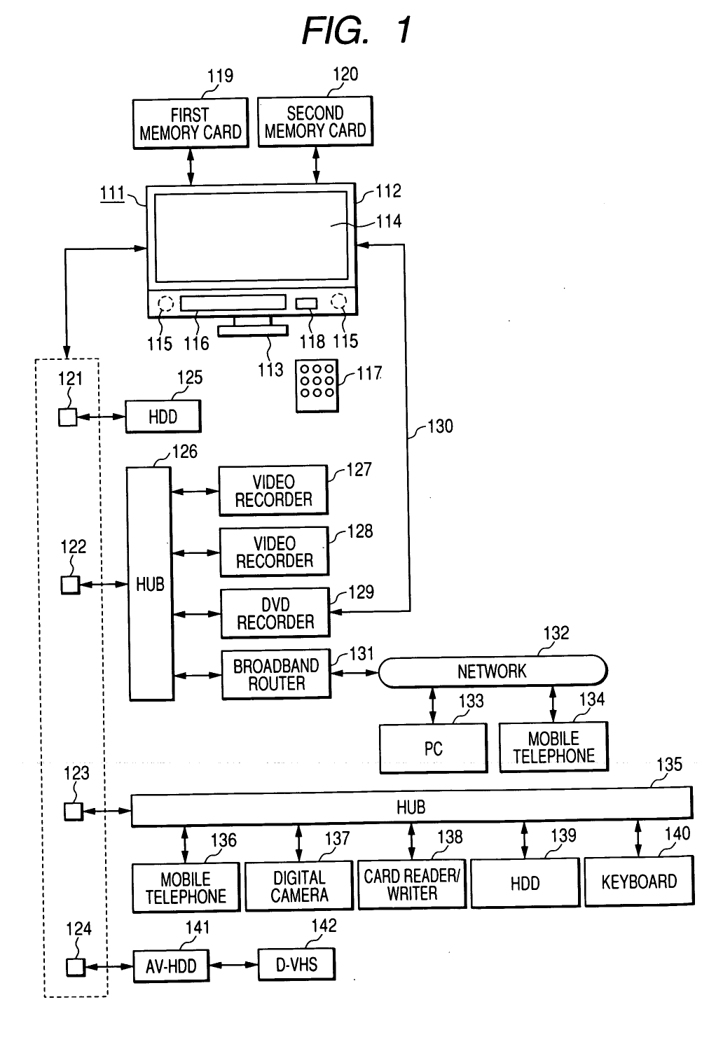

FIG. 1 schematically shows the appearance of a digital TV broadcast receiver 111 as shown as an embodiment and an example of a network system configured centering on the digital TV broadcast receiver 111.

The digital TV broadcast receiver 11 includes a slim cabinet 112 and a stand 113 that supports the cabinet 112 upright. The cabinet 112 is installed with: a flat panel display 114 implemented as a display such as an SED (Surface-conduction Electron-emitter Display) panel and a liquid crystal display panel; speakers 115; an operation panel 116; and a photoreceiver unit 118 that receives operation information transmitted from a remote controller 117.

For example, a first memory card 119, such as an SD (Secure Digital) memory card, an MMC (Multimedia Card), or a Memory Stick, can be attached to and detached from the digital TV broadcast receiver 111, and information of a program, a photo, etc., is recorded and is played back on the first memory card 119.

Further, a second memory card (IC card) 120 recording information, such as contract information, can be attached to and detached from the digital TV broadcast receiver 111, and information is recorded and is played back on the second memory card 120.

The digital TV broadcast receiver 111 includes a first LAN (Local Area Network) terminal 121, a second LAN terminal 122, a USB (Universal Serial Bus) terminal 123, and an IEEE1394 (i.LINK) terminal 124.

The first LAN terminal 121, which is used as a LAN compatible HDD dedicated port, is used to record and play back information through Ethernet (registered trademark) on a LAN compatible HDD 125 of connected NAS (Network Attached Storage).

The first LAN terminal 121 as the LAN compatible HDD dedicated port is provided. Accordingly, information of a program based on HDTV image quality can be stably recorded on the HDD 125 without being affected by any other network environment, or the network use situation.

The second LAN terminal 122, which is used as a general LAN compatible port using Ethernet (registered trademark), is used to connect devices such as a video recorder 127, a video recorder 128, and an HDD embedded DVD (digital versatile disk) recorder 129, for example, through a hub 126 for transferring information to and from the devices.

The video recorder 128 is implemented as a UPnP (Universal Plug and Play) compatible device having a function to operate as a content server in the home network and further including service for providing URI (Uniform Resource Identifier) information required for accessing content.

A dedicated analog transmission line 130 is provided for the DVD recorder 129 to transfer analog video and audio information to and from the digital TV broadcast receiver 111. This is because digital information communicated through the second LAN terminal 122 is information of only the control channel.

Further, the second LAN terminal 122 is used to connect a network 132, such as the Internet, through a broadband router 131 connected to the hub 126 for transferring information to and from a devices, such as a PC 133 and a mobile telephone 134, through the network 132.

The PC 133 is implemented as a UPnP compatible device having a function to operate as a content server and further including service for providing URI information required for accessing content.

The USB terminal 123, which is used as a general USB compatible port, is used to connect USB devices such as a mobile telephone 136, a digital camera 137, a card reader/writer 138 for a memory card, an HDD 139, and a keyboard 140, for example, through a hub 135 for transferring information to and from the USB devices.

Further, the IEEE1394 terminal 124 is used to connect an AV-HDD 141, a D (Digital)-VHS (Video Home System) 142, etc., for example, in series for transferring information to and from the devices.

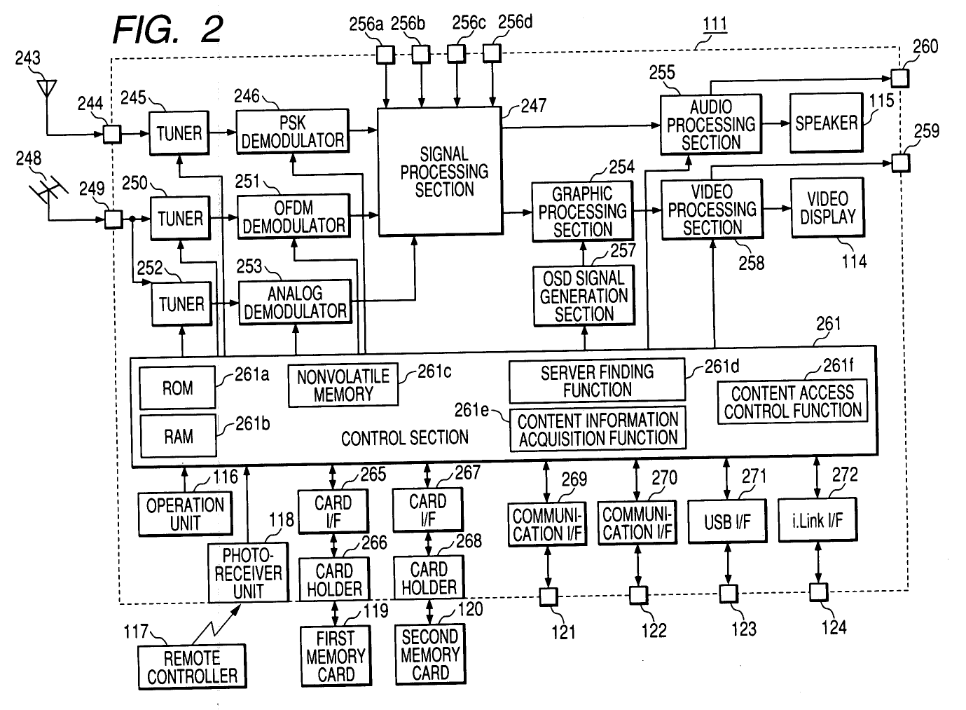

FIG. 2 shows the main signal processing channel of the digital TV broadcast receiver 111. That is, a satellite digital TV broadcast signal received at an antenna 243 for receiving BS/CS digital broadcasting is supplied through an input terminal 244 to a satellite digital broadcasting tuner 245, whereby the broadcast signal of any desired channel is selected.

The broadcast signal selected by the tuner 245 is supplied to a PSK (Phase Shift Keying) demodulator 246 and is demodulated into digital video and audio signals, which are then output to a signal processing section 247.

A terrestrial digital TV broadcast signal received at an antenna 248 for receiving terrestrial broadcasting is supplied through an input terminal 249 to a terrestrial digital broadcasting tuner 250, whereby the broadcast signal of any desired channel is selected.

The broadcast signal selected by the tuner 250 is supplied to an OFDM (Orthogonal Frequency Division Multiplexing) demodulator 251, for example, in Japan and is demodulated into digital video and audio signals, which are then output to the signal processing section 247.

A terrestrial analog TV broadcast signal received at the antenna 248 for receiving terrestrial broadcasting is supplied through the input terminal 249 to a terrestrial analog broadcasting tuner 252, whereby the broadcast signal of any desired channel is selected. The broadcast signal selected by the tuner 252 is supplied to an analog demodulator 253 and is demodulated into analog video and audio signals, which are then output to the signal processing section 247.

The signal processing section 247 selectively performs predetermined digital signal processing for the digital video and audio signals supplied from the PSK demodulator 246 and the OFDM demodulator 251, and outputs the signals to a graphic processing section 254 and an audio processing section 255.

A plurality of (in the figure, four) input terminals 256a, 256b, 256c, and 256d are connected to the signal processing section 247. The input terminals 256a to 256d make it possible to input analog video and audio signals from the outside of the digital TV broadcast receiver 111.

The signal processing section 247 selectively digitizes the analog video and audio signals supplied from the analog demodulator 253 and the input terminals 256a to 256d and performs predetermined digital signal processing for the digitized video and audio signals and then outputs the signals to the graphic processing section 254 and the audio processing section 255.

The graphic processing section 254 has a function of superposing an OSD (On Screen Display) signal generated by an OSD signal generation section 257 on the digital video signal supplied from the signal processing section 247 and outputting the resultant signal. The graphic processing section 254 can selectively output the output video signal of the signal processing section 247 and the output OSD signal of the OSD signal generation section 257 and can output both output signals in combination so as to form each a half of a screen.

The digital video signal output from the graphic processing section 254 is supplied to a video processing section 258. The video processing section 258 converts the input digital video signal into an analog video signal in a format that can be displayed on the video display 114 and then outputs the analog video signal to the video display 114 for displaying video and also outputs the signal to the outside through an output terminal 259.

The audio processing section 255 converts the input digital audio signal into an analog audio signal in a format that can be played back in the speakers 115 and then outputs the analog audio signal to the speakers 115 for playing back audio and also outputs the signal to the outside through an output terminal 260.

All operation of the digital TV broadcast receiver 111 including the various types of reception operation described above is controlled by a control unit 261. The control unit 261, which contains a CPU (Central Processing Unit), etc., receives operation information from the operation panel 116 or receives operation information sent from the remote control 17 through the photoreceiver unit 118 and controls the sections so as to reflect the operation description.

In this case, the control unit 261 uses mainly ROM (Read-Only Memory) 261a storing a control program executed by the CPU, RAM (Random Access Memory) 261b for providing a work area for the CPU, and nonvolatile memory 261c for storing various pieces of set information, control information, etc.

The control unit 261 is connected through a card I/F (Interface) 265 to a card holder 266 in which the first memory card 119 can be placed, whereby the control unit 261 can transfer information to and from the first memory card 119 placed in the card holder 266 through the card I/F 265.

Further, the control unit 261 is connected through a card I/F 267 to a card holder 268 in which the second memory card 120 can be placed, whereby the control unit 261 can transfer information to and from the second memory card 120 placed in the card holder 268 through the card I/F 267.

The control unit 261 is connected to the first LAN terminal 121 through a communication I/F 269, whereby the control unit 261 can transfer information to and from the LAN compatible HDD 125 connected to the first LAN terminal 121 through the communication I/F 269. In this case, the control unit 261 has a DHCP (Dynamic Host Configuration Protocol) server function and assigns an IP (Internet Protocol) address to the LAN compatible HDD 125 connected to the first LAN terminal 121 for control.

Further, the control unit 261 is connected to the second LAN terminal 122 through a communication I/F 270, whereby the control unit 261 can transfer information to and from the devices connected to the second LAN terminal 122 (see FIG. 1) through the communication I/F 270.

The control unit 261 is also connected to the USB terminal 123 through a USB I/F 271, whereby the control unit 261 can transfer information to and from the devices connected to the USB terminal 123 (see FIG. 1) through the USB I/F 271.

Further, the control unit 261 is connected to the IEEE1394 terminal 124 through an IEEE1394 I/F 272, whereby the control unit 261 can transfer information to and from the devices connected to the IEEE1394 terminal 124 (see FIG. 1) through the IEEE1394 I/F 272.

In the embodiment, a registration file describing the storage IDs (each containing IP address and device name) assigned to the HDD 125, the video recorder 127, the video recorder 128, and the DVD recorder 129 at the initial registration time is stored in the HDD 125.

The storage IDs of the HDD 125, the video recorder 127, the video recorder 128, and the DVD recorder 129 are stored in the nonvolatile memory 261c.

The control unit 261 includes (1) server finding function 261d using UPnP, (2) content information acquisition function 261e using UPnP, and (3) content access control function 261f.

(1) The control unit 261 finds a UPnP compatible device on the network using a UPnP discovery function by the server finding function 261d. For example, the server finding function 261d finds the video recorder 128 using the UPnP discovery function.

(2) The control unit 261 controls a UPnP compatible device using a UPnP control function by the content information acquisition function 261e and acquires URI information required for accessing the content in the UPnP compatible device. For example, the content information acquisition function 261e controls the video recorder 128 and acquires the URI information required for accessing the content stored in the HDD, etc., in the video recorder 128 from the video recorder 128.

(3) The control unit 261 determines whether or not access to content is permitted by the content access control function 261f based on the IP address information of the server acquired by the server finding function 261d, the IP address information obtained from the URI information acquired by the content information acquisition function 261e, and the IP address and net mask assigned to the second LAN terminal 122 of the digital TV broadcast receiver 111. If the control unit 261 determines that access is permitted, the control unit 261 permits content access; if the control unit 261 does not determine that access is permitted, the control unit 261 displays a message to the effect that access cannot be permitted on the video display 114 as OSD.

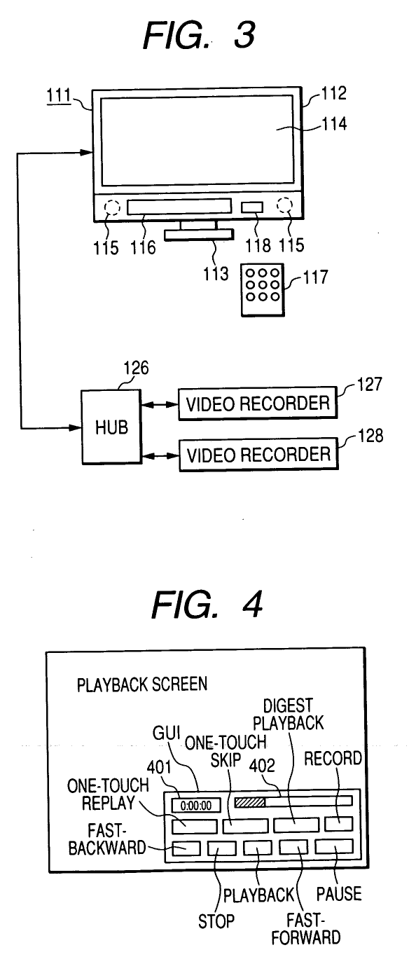

FIG. 3 is a drawing provided by extracting the configuration of a part of FIG. 1.

In FIG. 3, the digital TV broadcast receiver 111, the video recorder 127, and the video recorder 128 are network apparatus connected to a local area network.

The digital TV broadcast receiver 111 receives an MPEG2 transport stream and an MPEG2 program stream transmitted from the video recorder 127 and the video recorder 128 of other network apparatus connected to the local area network via the local area network, and produces video display and audio provided by decoding the received data. The digital TV broadcast receiver 111 may be a digital broadcast tuner, etc., as well as a digital broadcast TV receiver.

The video recorder 127 and the video recorder 128 exist on the local area network recognized by the digital TV broadcast receiver 111 and can be controlled via the local area network from the digital TV broadcast receiver 111 in accordance with a communication protocol between the apparatus.

The video recorder 127 and the video recorder 128 can record the MPEG2 transport stream and the MPEG2 program stream input via the local area network from other network apparatus connected to the local area network in a record DVD, an internal HDD, etc., included in the video recorder 127 and the video recorder 128.

The video recorder 127 and the video recorder 128 can transmit the MPEG2 transport stream and the MPEG2 program stream recorded in the record DVD, the internal HDD, etc., included in the video recorder 127 and the video recorder 128 to other network apparatus connected to the local area network via the local area network.

For example, a DVD record-playback device, an HDD record-playback device, and the like are available as specific products of the video recorder 127 and the video recorder 128.

The digital TV broadcast receiver 111 is connected to the video recorder 127 and the video recorder 128 through a wired or wireless local area network for controlling the video recorder 127 and the video recorder 128 via the local area network in accordance with the communication protocol between the apparatus. A “DLNA (digital living network alliance) guideline” is known as the communication protocol technique between the apparatus.

The digital TV broadcast receiver 111 presents a GUI as shown in FIG. 4 on the video display 114 of the digital TV broadcast receiver 111 as means for controlling other network apparatus connected to the local area network, enabling the user to remotely control the apparatus using the remote controller 117, etc.

FIG. 4 shows a GUI screen displayed on the video display 114 of the digital TV broadcast receiver 111; in this example, the GUI screen is provided for the user to operate the video recorder 127 or the video recorder 128.

As shown in FIG. 4, a playback button, a record button, a stop button, a pause button, a fast-forward button, a fast-backward button, a one-touch replay button, a one-touch skip button, and a digest playback button are placed as the GUI. Further, a counter 401, a time bar 402, and the like for presenting progress information during the playback operation and the record operation are also presented on the GUI. The GUI presentation is generated by the OSD signal generation section 257 in FIG. 2 and is superposed on the decoded video signal by the graphic processing section 254. The operation buttons such as the playback button, the record button, the stop button, the pause button, the fast-forward button, the fast-backward button, the one-touch replay button, the one-touch skip button, and the digest playback button of the GUI generating data (operation guide information) are not provided by the controlled device. The GUI generating data are previously recorded on a storage unit such as memory device in the digital TV broadcast receiver 111.

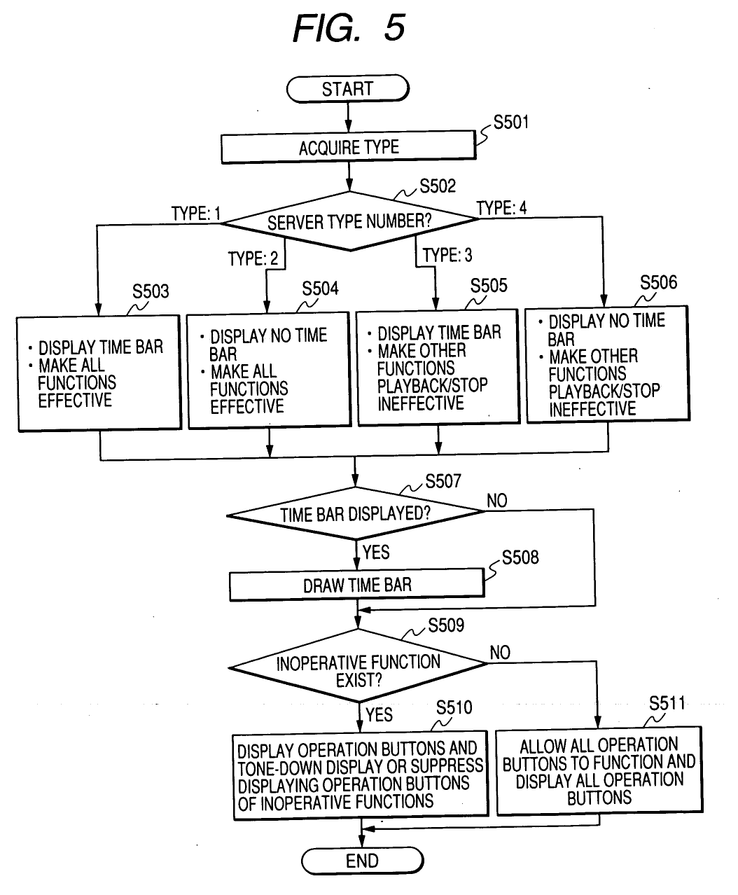

Next, the operation of the digital TV broadcast receiver 111, the control apparatus according to the embodiment, will be discussed with a flowchart of FIG. 5.

The operation of the digital TV broadcast receiver 111 for the user to control the video recorder 127 found from the local area network using the digital TV broadcast receiver 111 is as follows:

Block S501: The digital TV broadcast receiver 111 acquires the server type number of the video recorder 127 through the communication protocol. For example, the digital TV broadcast receiver 111 checks whether or not the video recorder 127 is supported with RANGE GET request (Get with range request) in HTTP protocol through the communication protocol. To make possible special playback other than playback or stop, the apparatus needs to be supported with RANGE GET request in HTTP protocol. To execute skip of special playback, it is impossible to acquire data with any desired byte or any desired time specified as the start position and the end position if the apparatus is not supported with RANGE GET request in HTTP protocol.

At block S501, if the video recorder 127 is supported with RANGE GET request in HTTP protocol, the server type number is determined as “1” or “2”; if the video recorder 127 is not supported with RANGE GET request in HTTP protocol, the server type number is determined as “3” or “4”.

To make the time bar effective, the total time of content needs to be able to be acquired. If the video recorder 127 can provide information of the total time of content, the server type number is determined as “1” or “2”; if the video recorder 127 cannot provide information of the total time of content, the server type number is determined as “3” or “4”.

Block S502: The digital TV broadcast receiver 111 determines the server type number acquired at block S501 to determine whether or not there is a restriction on the functions operated from any other network apparatus. According to the determination result, the digital TV broadcast receiver 111 proceeds the process to block S503 when the server type number is “1”; block S504 when the server type number is “2”; block S505 when the server type number is “3:; or block S506 when the server type number is “4”.

The digital TV broadcast receiver 111 determines the server type from the server type number and determines which function is effective by the determined type. As an example in the embodiment, it is assumed that the digital TV broadcast receiver 111 determines that when the server type number is “1”, “all functions are effective” and “time bar function is effective”, that when the server type number is “2”, “all functions are effective” and “time bar function is ineffective”, that when the server type number is “3”, “functions other than playback/stop are ineffective” and “time bar function is effective”, and that when the server type number is “4”, “functions other than playback/stop are ineffective” and “time bar function is ineffective.”

Block S503: The digital TV broadcast receiver 111 determines that “all functions are effective” and “time bar function is effective” because the server type number is “1”.

Block S504: The digital TV broadcast receiver 111 determines that “all functions are effective” and “time bar function is ineffective” because the server type number is “2”.

Block S505: The digital TV broadcast receiver 111 determines that “functions other than playback/stop are ineffective” and “time bar function is effective” because the server type number is “3”.

Block S506: The digital TV broadcast receiver 111 determines that “functions other than playback/stop are ineffective” and “time bar function is ineffective” because the server type number is “4”.

Block S507: If it is determined that the time bar display function is effective in response to the determination result at block S503 to block S506, the digital TV broadcast receiver 111 proceeds the process to block S508 and displays the time bar; if it is determined that the time bar display function is ineffective, the digital TV broadcast receiver 111 does not display the time bar and proceeds the process to block S509.

Block S508: The time bar is displayed.

Block S509: For example, if all functions are operative like “all functions effective” in response to the determination result at block S503 to block S506, the digital TV broadcast receiver 111 proceeds the process to block S510; if not all functions are operative as “functions other than playback/stop are ineffective,” the digital TV broadcast receiver 111 proceeds the process to block S511.

Block S510: All operation buttons are allowed to function and are displayed.

Block S511: Operation buttons of ineffective functions are displayed to be toned-down (displayed to be disabled, invalidated, or inactivated, in other words) and are not allowed to function (or are not displayed) and other effective operation buttons are displayed. The tone-down displayed buttons, etc., do not function even if the user presses a selection determination key when operating an operation guide by remote control operation.

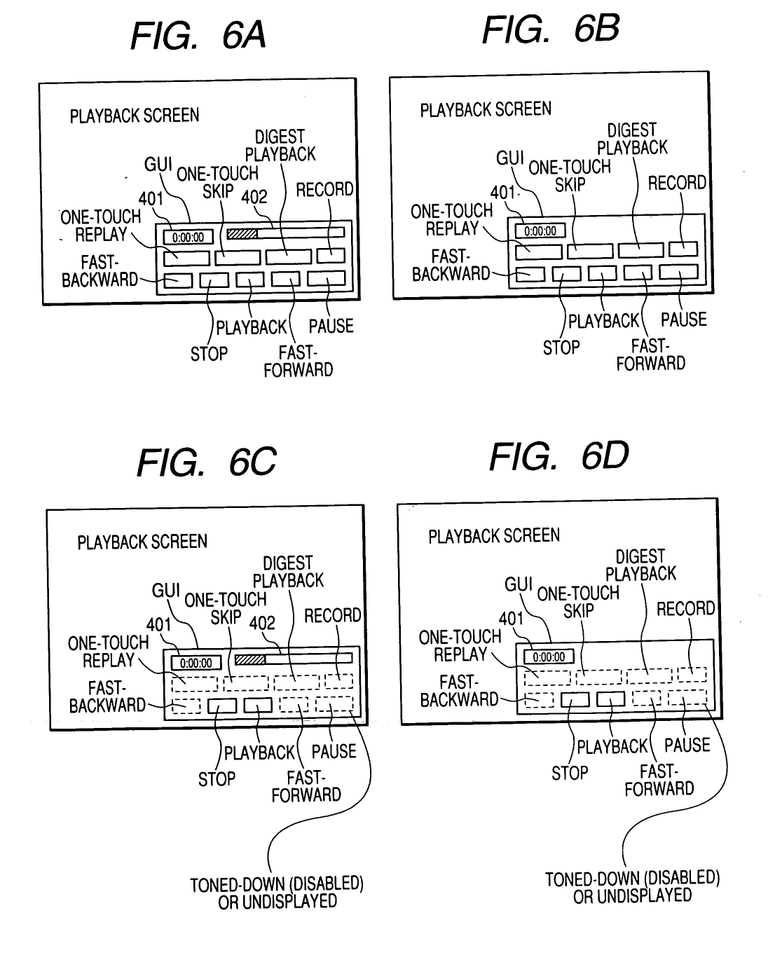

That is, when the server type number is “1”, the digital TV broadcast receiver 111 draws all buttons of the operation guide and the time bar 402 as the GUI on the video display 114 finally as shown in FIG. 6A.

When the server type number is “2”, the digital TV broadcast receiver 111 draws all buttons of the operation guide as the GUI on the video display 114 finally as shown in FIG. 6B, but tone-down displays the time bar 402 and does not allow the time bar 402 to function (or does not display the time bar 402).

When the server type number is “3”, the digital TV broadcast receiver 111 draws the playback button and the stop button of the operation guide and the time bar 402 as the GUI on the video display 114 finally as shown in FIG. 6C. At this time, the digital TV broadcast receiver 111 tone-down displays other buttons than the playback button or the stop button and does not allow other buttons to function (or does not display other buttons), as shown in FIG. 6C.

When the server type number is “4”, the digital TV broadcast receiver 111 draws the playback button and the stop button of the operation guide and tone-down displays the time bar 402 and does not allow the time bar 402 to function (or does not display the time bar 402) as the GUI on the video display 114 finally as shown in FIG. 6D. At this time, the digital TV broadcast receiver 111 tone-down displays other buttons than the playback button or the stop button and does not allow other buttons to function (or does not display other buttons), as shown in FIG. 6D.

Since the server type number “4” means that other functions than playback/stop are ineffective, other buttons than playback/stop in the operation guide are tone-down drawn.

The tone-down drawn ineffective functions do not work even if the user presses the selection determination key when operating the operation guide by remote control operation.

As a modified example of the embodiment described above, the design of the operation guide may be changed in accordance with the combination of the restricted functions (ineffective functions) for enabling the user to understand the operative functions through intuition rather than tone-down display of the buttons of the ineffective functions, etc.

The embodiment typically is implemented as a computer controlled by software. The software in this case includes a program and data, the functions and effects of the invention are provided by making the most of computer hardware physically, and appropriate related arts are applied to portions where the related arts can be applied. Further, the specific types and configurations of hardware and software for embodying the invention, the software processing range, and the like can be changed as desired. Therefore, in the description that follows, a virtual function block diagram indicating the component functions of the invention as blocks is used. A program for operating a computer to embody the invention is also one form of the invention.

As described above with reference to the embodiment, there is provided a control apparatus for enabling the user to understand whether or not control of a controlled apparatus is effective by function according to GUI display without transmitting a large number of pieces of data or information.

The invention relating to the apparatus and device also hold as the invention relating to a method and the invention relating to the method also holds as the invention relating to the apparatus. Accordingly, the user can operate only the effective functions through intuition.

The invention relating to the apparatus or the method also holds as a program for causing a computer to execute a procedure corresponding to the invention (or causing a computer to function as means corresponding to the invention or causing a computer to provide functions corresponding to the invention) and also holds as a computer-readable record medium recording the program.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

While certain embodiment of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control apparatus for controlling a controlled apparatus connected to a computer network via the computer network, the control apparatus comprising:
a detection unit that detects a type of the controlled apparatus;
a storage unit that stores operation guide information for generating an operation guide as a graphical user interface to control the controlled apparatus;
an operation image display unit that displays the operation guide, in which a function among a plurality of functions is activated in accordance with the type detected by the detection unit, the function being operative in the controlled apparatus; and
a transmission unit that transmits to the controlled apparatus via the computer network a control signal for performing a control responsive to a user operation input through the operation guide displayed by the operation image display unit.

2. The control apparatus according to claim 1, wherein the operation image display unit displays the operation guide, in which a function inactivated is displayed to be disabled or undisplayed.

3. The control apparatus according to claim 1, wherein the operation image display unit changes design of the operation guide in accordance with a combination of the function inactivated in accordance with the type detected by the detection unit.

4. The control apparatus according to claim 1, wherein the detection unit detects the type based on whether or not the controlled apparatus is supported with RANGE GET request in HTTP protocol.

5. The control apparatus according to claim 1, wherein the detection unit detects the type based on whether or not the controlled apparatus is supported with providing information of a total time of a content to be transmitted.

6. A control method for controlling a controlled apparatus connected to a computer network via the computer network, the control method comprising:
detecting a type of the controlled apparatus;
storing operation guide information for generating an operation guide as a graphical user interface to control the controlled apparatus;
displaying the operation guide, in which a function among a plurality of functions is activated in accordance with the detected type, the function being operative in the controlled apparatus; and
transmitting to the controlled apparatus via the computer network a control signal for performing a control responsive to a user operation input through the displayed operation guide.

7. The control method according to claim 6, wherein the operation guide is displayed in a manner, in which a function inactivated is displayed to be disabled or undisplayed.

8. The control method according to claim 6, wherein the operation guide is changed in design in accordance with a combination of the function inactivated in accordance with the detected type.

9. The control method according to claim 6, wherein the type is detected based on whether or not the controlled apparatus is supported with RANGE GET request in HTTP protocol.

10. The control method according to claim 6, wherein the type is detected based on whether or not the controlled apparatus is supported with providing information of a total time of a content to be transmitted.
